(19) United States
(12) Patent Application Publication
(10) Pub. No.: US 2009/0113901 A1
(43) Pub. Date: May 7, 2009

(54) Method and Apparatus for Servicing a Coolant System

(75) Inventors: Vincent F. Carrubba, Belle Harbor, NY (US); Ken Motush, Irvington, NY (US)

Correspondence Address: MEYERTONS, HOOD, KIVLIN, KOWERT & GOETZEL, P.C., P.O. BOX 398, AUSTIN, TX, 78767-0398, US

(73) Assignee: Interdynamics Inc., Tarrytown, NY (US)

(21) Appl. No.: 11/936,493

(22) Filed: Nov. 7, 2007

(51) Int. Cl. F25B 45/00; G01L 15/00

(52) U.S. Cl. 62/77; 73/736

(57) ABSTRACT

A method and an apparatus for servicing a coolant system is disclosed. Using the apparatus, a user may fill the coolant system with coolant. The user may also measure a current pressure of the coolant system. The apparatus then compares the current pressure with a predetermined pressure associated with an ambient temperature to determine a coolant charge status. The apparatus alerts a user to the coolant charge status of the coolant system using an indicating device.

### BACKGROUND OF THE INVENTION

1. Field of the Invention

The present invention relates to an apparatus and a method for servicing a coolant system and in particular to servicing a coolant system in a motor vehicle.

2. Description of Related Art

Many coolant systems, such as, automobile air conditioners, use chemicals called refrigerants to cool air. The refrigerants may be added to the coolant system as liquids, but utilized in the system as gases.

The ability to achieve cooling by compressing and expanding a gaseous refrigerant may depend to some degree on the level of liquid refrigerant present in the system. In an automobile air conditioning system, several factors may adversely affect the level of refrigerant in the system. For example, the system may be subject to significant swings in temperature and frequent thermal cycling due to the action of the air conditioner itself and the heat produced by the automobile's engine. Under these conditions, joints and fittings may tend to expand and contract, permitting refrigerant to slowly leak out of the system. In another example, the hoses used may be slightly permeable to the refrigerant, which may also permit the refrigerant to slowly leak out of the hoses. Accordingly, maintenance of an automobile air conditioning system may require monitoring the refrigerant level or pressure and periodic re-charging of the refrigerant as indicated.

Typical automotive air conditioners are provided with at least one service port to allow for the addition of refrigerant and checking on the level of refrigerant in the system. The check of refrigerant level and the addition of refrigerant may be attended to by a professional mechanic, however, there is no requirement that a professional carry out these functions. A growing number of automobile owners choose to perform this type of routine maintenance on their vehicles. This market is commonly referred to as the “do-it-yourself” market.

A standard tool used by professionals for servicing automobile air conditioners includes a set of manifold gauges. This device usually includes three hoses and two gauges: one hose connects to a low pressure service port; one hose connects to a high pressure service port; and the third hose connects to the source of refrigerant. The two gauges may be used to measure the pressure at the high and low pressure service ports.

Although manifold gauges are the standard tool used by professional auto mechanics for air conditioner service, several disadvantages may reduce their popularity among do-it-yourself consumers. Manifold gauges can be complicated to use. One must know the approximate ambient temperature and look up the pressure readings of the gauges on a chart to determine if there is sufficient refrigerant in the system. In addition, use of manifold gauges may be dangerous. Because these devices require handling of the high pressure service port of the automobile air conditioner, their use may present a risk of injury to inexperienced consumers. Furthermore, manifold gauges may be relatively expensive for a “do-it yourself” consumer considering the relative infrequency of their use for servicing of a single automobile. Accordingly, there is a need for new methods and an apparatus for servicing air conditioners, such as those used in automobiles, which do not have the same drawbacks as manifold gauges.

### SUMMARY OF THE INVENTION

A method and apparatus for servicing a coolant system is disclosed. In one aspect, the invention provides an apparatus for servicing a coolant system adapted to receive coolant from a coolant supply, comprising: a first measuring device configured to measure a current pressure associated with the coolant system; a second measuring device configured to measure a current ambient temperature; a storage device configured to store a set of predetermined pressures associated with current ambient temperatures; and a control unit in communication with the first measuring device, the second measuring device and the storage device configured to determine a coolant charge status; and an indicating device in communication with the control unit configured to alert a user of the coolant charge status.

In another aspect, the first measuring device is a Bourdon tube pressure gauge fitted with a quadrature encoder.

In another aspect, the second measuring device is a thermistor.

In another aspect, the indicating device is a display device.

In another aspect, the display device includes at least one LED light.

In another aspect, the indicating device includes an audio device.

In another aspect, the audio device includes a voice processor and a speaker.

In another aspect, the invention provides a method of servicing a coolant system using an apparatus attached to a coolant supply, comprising the steps of: receiving information related to a current pressure of the coolant system and receiving information related to a current ambient temperature; retrieving a predetermined pressure associated with the current ambient temperature from a storage device; comparing the current pressure with the predetermined pressure and determining a coolant charge status; and sending information related to the coolant charge status to an indicating device for alerting a user.

In another aspect, a plurality of predetermined pressures associated with a plurality of ambient temperatures is stored in a lookup table associated with the storage device.

In another aspect, the apparatus includes a switching device.

In another aspect, the switching device is configured to provide fluid communication between the coolant system and the coolant supply in a first position.

In another aspect, the switching device is configured to provide fluid communication between the coolant system and a first measuring device in a second position.

In another aspect, the switching device can be configured in either the first position or the second position using one or more levers.

In another aspect, the indicating device includes a plurality of LED lights.

In another aspect, the step of sending information related to the coolant charge status includes a step of activating one of the plurality of LED lights.

In another aspect, the indicating device includes an audio device.

In another aspect, the step of sending information related to the coolant charge status includes a step of activating a speaker associated with the audio device.

In another aspect, the invention provides an apparatus for servicing a coolant system adapted to receive coolant from a coolant supply, comprising: a first measuring device configured to measure a current pressure associated with the coolant system; a second measuring device configured to measure a current ambient temperature; a switching device providing fluid communication between the coolant system and the coolant supply in a first position and providing fluid communication between the coolant system and the first measuring device in a second position; a control unit in communication with the first measuring device, the second measuring device and the switching device; and where the control unit receives information from the second measuring device when the switching device is in the first position and where the control unit receives information from the first measuring device when the switching device is in the second position.

In another aspect, the control unit is in communication with a storage device including a plurality of predetermined pressures associated with a plurality of ambient temperatures.

In another aspect, the control unit is in communication with an indicating device that is configured to alert a user of a coolant charge status.

Other systems, methods, features and advantages of the invention will be, or will become, apparent to one of ordinary skill in the art upon examination of the following figures and detailed description. It is intended that all such additional systems, methods, features and advantages be included within this description and this summary, be within the scope of the invention, and be protected by the following claims.

### BRIEF DESCRIPTION OF THE DRAWINGS

The invention can be better understood with reference to the following drawings and description. The components in the figures are not necessarily to scale, emphasis instead being placed upon illustrating the principles of the invention. Moreover, in the figures, like reference numerals designate corresponding parts throughout the different views.

FIG. 1 is a schematic view of a preferred embodiment of an apparatus for servicing a coolant system;

FIG. 2 is a front view of a preferred embodiment of an apparatus for servicing a coolant system;

FIG. 3 is an interior view of a preferred embodiment of an apparatus for servicing a coolant system;

FIG. 4 is a preferred embodiment of a process for using an apparatus to service a coolant system;

FIG. 5 is a preferred embodiment of a process for using an apparatus to service a coolant system;

FIG. 6 is an exemplary embodiment of a lookup table of ambient temperatures associated with predetermined pressures for a low pressure service port;

FIG. 7 is a preferred embodiment of a process for determining a coolant charge status;

FIG. 8 is a schematic view of a preferred embodiment of an apparatus charging a coolant system;

FIG. 9 is a schematic view of a preferred embodiment of an apparatus servicing a coolant system;

FIG. 10 is a schematic view of a preferred embodiment of an apparatus servicing a coolant system;

FIG. 11 is a schematic view of a preferred embodiment of an apparatus servicing a coolant system; and

FIG. 12 is a schematic view of a preferred embodiment of an apparatus servicing a coolant system.

### DETAILED DESCRIPTION OF THE PREFERRED EMBODIMENTS

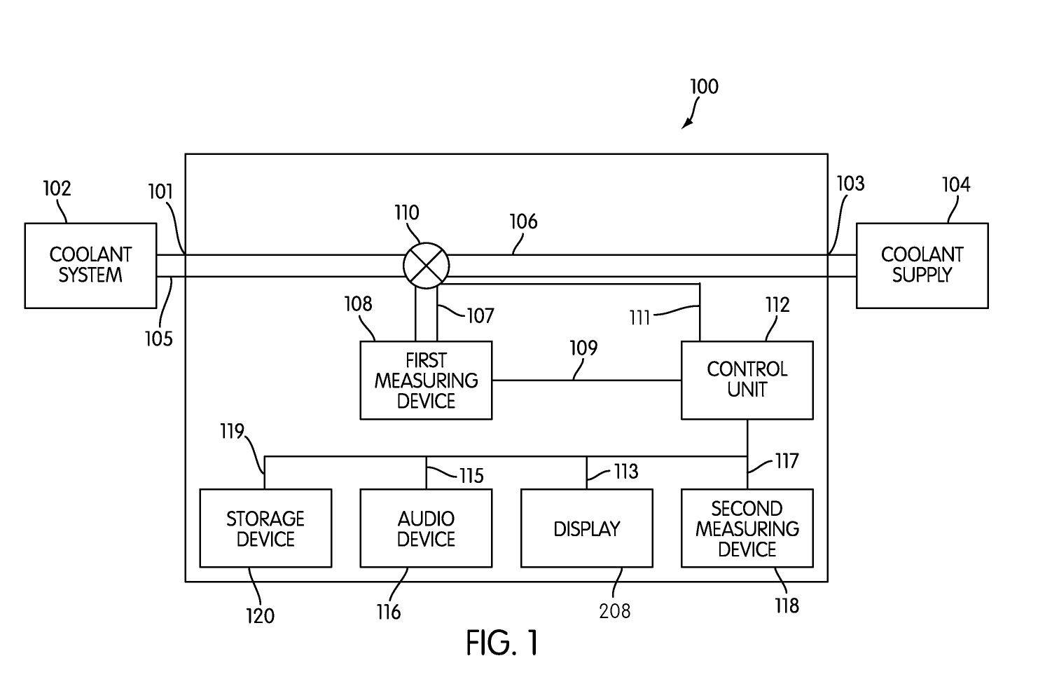

FIG. 1 is a schematic diagram of a preferred embodiment of apparatus 100 that is configured to service coolant system 102. Apparatus 100 may be used to determine the amount of coolant in coolant system 102 and in some cases, add coolant to coolant system 102 using coolant supply 104. It should be understood that the components 102, 100 and 104 are not necessarily drawn to scale in the current embodiment. Instead, the size of apparatus 100 is exaggerated in order to illustrate the many components of apparatus 100.

Generally, coolant system 102 could be any type of air conditioner. Examples include, but are not limited to, R-134a systems, orifice tube systems, thermal expansion valve systems, receiver-drier systems, automatic temperature control systems, combinations of the previous systems or any other type of air conditioner. In a preferred embodiment, coolant system 102 may be configured to be used in an automobile.

Apparatus 100 may be employed by a professional mechanic, an automobile owner, or a person with no training in servicing coolant systems. Generally, a user of apparatus 100 may be a “do-it-yourself” consumer that is not trained in servicing coolant systems. In other embodiments, however, a user may be a mechanic or a service technician.

Preferably, apparatus 100 is configured to connect to coolant system 102 during servicing. In some embodiments, apparatus 100 may connect to coolant system 102 at a low pressure service port. In other embodiments, apparatus 100 may connect to coolant system 102 at a high pressure service port. Furthermore, apparatus 100 may connect to coolant system 102 using a hose with a coupler adapted to connect to coolant system 102. In some cases, the coupler may be a quick-connect coupler. In this embodiment, apparatus 100 connects to coolant system 102 using hose 105, which includes a quick-connect coupler adapted to connect to a low pressure service port of coolant system 102.

Apparatus 100 may also be configured to connect to coolant supply 104. Generally, coolant supply 104 may be associated with an Acme threaded container or other suitable container and filled with any type of coolant. Examples of coolants include, but are not limited to, R134a, R-12 or any other type of refrigerant. In an alternative embodiment, coolant supply 104 may further include other suitable chemicals, such as, for example, leak detector and/or system lubricant.

In some embodiments, apparatus 100 may include one or more fluid channels. In this preferred embodiment, apparatus 100 preferably includes fluid channel 106. Fluid channel 106 may be configured to connect to coolant system 102 through hose 105 at first fluid port 101. Furthermore, fluid channel 106 may be configured to connect to coolant supply 104 at second fluid port 103. As previously discussed in the coolant system case, this configuration allows apparatus 100 to charge coolant system 102 with coolant from coolant supply 104. In other words, coolant system 102 and coolant supply 104 may be in fluid communication through fluid channel 106.

When servicing a coolant system, a user may want to measure a parameter of the coolant system. In some cases, the user may need to know the current pressure of the coolant system in order to properly charge the coolant system with coolant. Preferably, an apparatus configured to service a coolant system may include provisions for measuring one or more parameters of the coolant system, including pressure. By measuring the internal pressure of a coolant system, the amount of coolant within the coolant system can be indirectly determined.

In this embodiment, apparatus 100 may include first measuring device 108. First measuring device 108 may be configured to measure one or more parameters of coolant system 102. In some cases, first measuring device 108 may be a pressure sensor that is configured to measure the pressure of coolant system 102. For example, first measuring device 108 may be a gauge pressure sensor. In other embodiments, first measuring device 108 may be a flow sensor. In still other embodiments, first measuring device 108 may be any type of sensor configured to measure one or more parameters associated with coolant system 102. In this preferred embodiment, first measuring device 108 is a Bourdon tube pressure gauge fitted with a quadrature encoder.

In some embodiments, first measuring device 108 may be in fluid communication with coolant system 102 in order to measure the current pressure of coolant system 102. In this embodiment, first measuring device 108 may be associated with coolant system 102 through fluid channel 106. In particular, first measuring device 108 may be connected to fluid channel 106 at third fluid port 107.

In some embodiments, apparatus 100 may include provisions for controlling the flow of fluid between one or more fluid ports. In some cases, apparatus 100 may include a switching device. In this embodiment, apparatus 100 preferably includes switching device 110. Examples of switching devices include, but are not limited to mechanical valves, pneumatic valves, electric valves as well as other types of devices for changing the flow of fluid through various fluid channels.

Using this arrangement, switching device 110 performs selective switching by allowing communication between different ports on fluid channel 106. In this case, while apparatus 100 charges coolant system 102, switching device 110 is in a first position and provides communication between coolant system 102 and coolant supply 104 through fluid channel 106. Likewise, while first measuring device 108 measures the current pressure of coolant system 102, switching device 110 is in a second position and provides communication between coolant system 102 and first measuring device 108 through fluid channel 106. As previously discussed in the coolant system case, switching device 110 substantially prevents communication between coolant system 102 and first measuring device 108 when coolant system 102 communicates with coolant supply 104. Furthermore, switching device 110 substantially prevents communication between coolant system 102 and coolant supply 104 when first measuring device 108 communicates with coolant system 102.

Generally, switching device 110 may be operated using any known method. In some embodiments, switching device 110 may be operated using mechanical provisions. In other embodiments, an electronic button may be used to operate switching device 110. In a preferred embodiment, switching device 110 may be operated using one or more mechanical levers as previously discussed in the coolant system case.

Preferably, an apparatus that determines the current pressure of a coolant system includes provisions for determining the correct pressure for efficient operation of the coolant system. This correct pressure may be predetermined according to a current ambient temperature. When volume is held constant, an increase in temperature will cause an increase in pressure as described by the Ideal Gas Law. Because the volume of coolant system 102 is constant, the correct pressure used for efficiently operating coolant system 102 will be a function of the current ambient temperature.

In this embodiment, apparatus 100 includes second measuring device 118 configured to measure the current ambient temperature. Second measuring device 118 may be any type of sensor used for measuring temperature including, but not limited to, thermistors and resistance thermometers. In this preferred embodiment, second measuring device 118 is a thermistor.

Apparatus 100 may include provisions for sending and receiving information from one or more components of apparatus 100, as well as for controlling various components of apparatus 100. In some embodiments, apparatus 100 may include control unit 112. In some cases, control unit 112 may be an electronic control unit of some kind. In a preferred embodiment, control unit 112 may be a central processing unit (CPU) or another type of microprocessor.

Control unit 112 may be associated with, and configured to receive information from, first measuring device 108 and second measuring device 118. In this embodiment, first measuring device 108 may be connected to control unit 112 through connection 109. Using this configuration, control unit 112 may receive information on the current pressure of coolant system 102 from first measuring device 108. Additionally, in some embodiments, second measuring device 118 may be associated with control unit 112. In this embodiment, second measuring device 118 may be configured to communicate with control unit 112 through connection 117. Using this arrangement, control unit 112 may receive information on the current ambient temperature from second measuring device 118.

In some embodiments, switching device 110 may also be associated with control unit 112. In this embodiment, switching device 110 may be connected to control unit 112 through connection 111. This arrangement allows control unit 112 to receive information on the current position of switching device 110.

Preferably, apparatus 100 includes provisions for determining a correct operating pressure for a coolant system given the current ambient temperature. In some embodiments, predetermined pressures, corresponding to correct operating pressures, for associated ambient temperatures may be determined at the time of manufacturing. In a preferred embodiment, predetermined pressures and associated ambient temperatures may be stored as a lookup table.

In this preferred embodiment, a lookup table with predetermined pressures associated with ambient temperatures may be stored within storage device 120. In some embodiments, storage device 120 may be associated with the internal memory of control unit 112. In other embodiments, storage device 120 may be external to control unit 112. In this preferred embodiment, storage device 120 is separate from control unit 112 and connected to control unit 112 via connection 119. This preferred arrangement allows control unit 112 to access the lookup table stored in storage device 120.

Generally, a coolant system may be associated with a coolant charge status. The term “coolant charge status” as used through this detailed description and in the claims, refers to various configurations of the coolant system, including undercharged, overcharged or charged configurations. In the undercharged configuration, more coolant is required for proper functioning of the coolant system. In the overcharged configuration, some coolant should be removed from the coolant system so that the coolant system can operate properly. Finally, in the charged configuration, the coolant system has been filled with the proper amount of coolant.

In this preferred embodiment, the coolant charge status may be determined by measuring a current pressure of coolant system 102 and accessing a predetermined pressure associated with the current ambient temperature. This predetermined pressure may be the pressure at which coolant system 102 operates most efficiently, for a given ambient temperature. When the current pressure is significantly less than the predetermined pressure, the system is undercharged. Additionally, when the current pressure is approximately equal to the predetermined pressure, the system is properly charged. Finally, when the current pressure is significantly greater than the predetermined pressure, the system is overcharged. In addition, in some embodiments, the coolant charge status could also take on additional values, such as slightly undercharged, well undercharged, slightly overcharged, well overcharged, as well as other possible values.

Preferably, an apparatus for servicing a coolant system includes provisions to alert a user to the current pressure and/or the coolant charge status of the coolant system. In some embodiments, a control unit may be configured to communicate the current pressure of a coolant system to a user. In other embodiments, a control unit may be configured to alert a user of a coolant charge status. Generally, an apparatus may have provisions to convey any information required for the operation of the apparatus and the coolant system to a user. For example, a control unit may be configured to signal a user that a measuring device is ready to measure a parameter of the coolant system. In a preferred embodiment, a control unit may be configured to communicate the coolant charge status of the coolant system.

In some embodiments, apparatus 100 may include one or more indicating devices to alert a user of the current pressure and coolant charge status of coolant system 102. In some cases, apparatus 100 may include an indicating device that is a display. In other cases, apparatus 100 may utilize an audio device capable of generating sound or speech recordings as an indicating device. In some cases, apparatus 100 may include an indicating device that is an audio device with drivers suitable for driving a speaker and memory to store speech files for playback. In this preferred embodiment, apparatus 100 includes two indicating devices, audio device 116 and display 208. In other embodiments, however, audio device 116 and display 208 may be optional and used independently of one another.

In this embodiment, audio device 116 is a WINBOND W588S003 system microcontroller with drivers for driving a speaker, memory to store speech files for playback and special registers to play the stored sound files. With this arrangement, audio device 116 may play stored audio files to “read” the current pressure of coolant system 102 or signal the coolant charge status of coolant system 102. These audio files could be electronic beeps, vocal recordings, or other types of audio files.

Generally, display 208 may be any type of display. In some embodiments, display 208 may be an LED display. In other embodiments, display 208 may be an LCD screen or another type of display. In a preferred embodiment, display 208 may be configured to display the coolant charge status of coolant system 102. In still other embodiments, display 208 could be configured to display the current pressure of coolant system 102.

In this embodiment, control unit 112 may be configured to communicate with display 208 and audio device 116 through connections 113 and 115, respectively. Using this arrangement, control unit 112 may signal display 208 and audio device 116 to inform a user of the current pressure and coolant charge status of coolant system 102 as well as to alert a user of any other information relevant to coolant system 102 or apparatus 100.

Generally, connections 109, 111, 113, 115, 117 and 119 may be any type of connection. In some cases, connections 109, 111, 113, 115, 117 and 119 may be wired connections such as electrical wires. In other cases, connections 109, 111, 113, 115, 117 and 119 may be wireless connections. In still other embodiments, connections 109, 111, 113, 115, 117 and 119 may be a mix of both wired and wireless connections. In some cases, for example, these connections could be soldering or electron traces on circuit boards.

While this preferred embodiment includes control unit 112, an apparatus need not include a control unit in other embodiments. In these other embodiments, one or more components of the apparatus, such as measuring and switching devices, may be directly connected to each other. Communication may occur directly between components instead of being organized through a control unit. For example, first measuring device 108 and second measuring device 118 may communicate directly with storage device 120 to determine a predetermined pressure for an associated ambient temperature. Additionally, first measuring device 108 or second measuring device 118 may be designed to send signals directly to audio device 116 and display 208 to alert a user to the coolant charge status of coolant system 102.

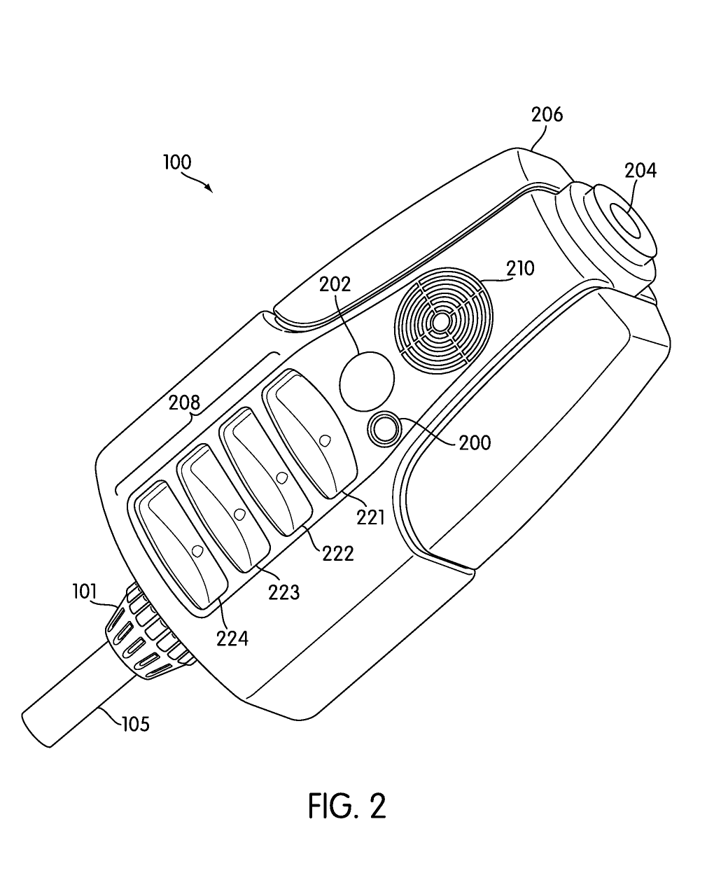

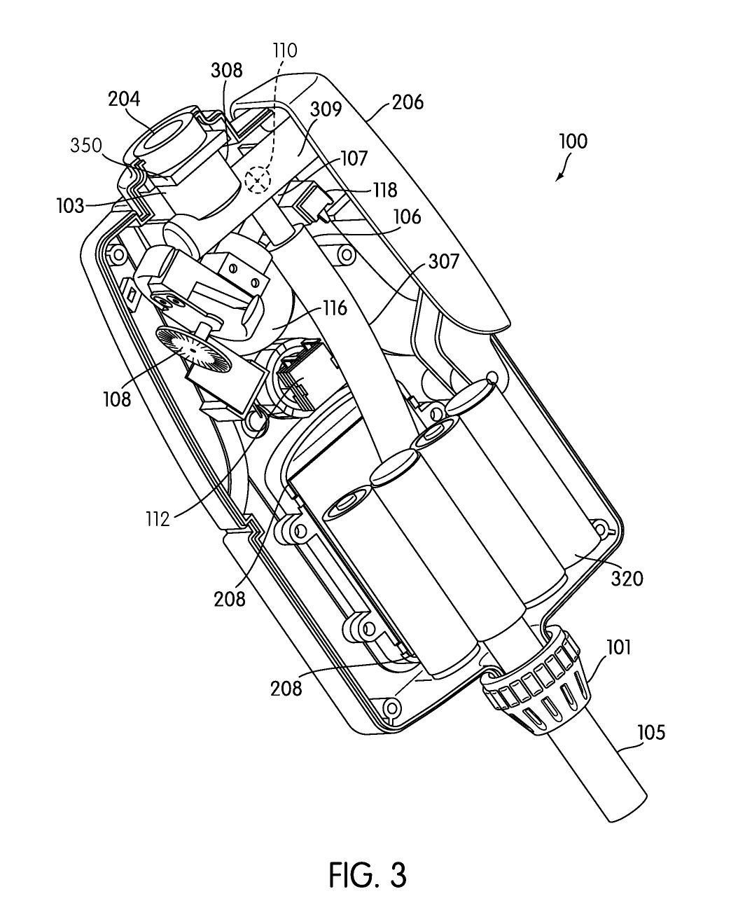

FIGS. 2 and 3 illustrate a preferred embodiment of apparatus 100. In some embodiments, apparatus 100 may include hose 105. For clarity, only a portion of hose 105 is illustrated in the current embodiment. As previously discussed, hose 105 may be used to connect apparatus 100 with a coolant system. Specifically, a first end of hose 105 may be in communication with first fluid port 101 of apparatus 100 and a second end of hose 105, not shown in the Figures, may be connected to a low pressure service port of coolant system 102.

Preferably, apparatus 100 includes receiving end 204 configured to attach to a coolant supply. In some embodiments, an adapter including a threaded bore may be necessary for connecting receiving end 204 to a coolant supply. In other embodiments, receiving end 204 may include a piercing member to pierce a seal on the top of a coolant supply when apparatus 100 is connected to a coolant supply. In a preferred embodiment, receiving end 204 includes a piercing member and an adapter with a threaded bore to pierce and connect to a coolant supply.

The orientation of receiving end 204 and hose 105 is intended to be illustrative only, and not limiting. With reference to FIG. 2, receiving end 204 is located at a top side of apparatus 100 and hose 105 connected at a bottom side of apparatus 100. In other embodiments, other orientations of receiving end 204 and hose 105 may be possible including locating receiving end 204 at a bottom side of apparatus 100 and hose 105 at a top side of apparatus 100.

In some embodiments, apparatus 100 may include provisions for turning on or beginning operations. In other embodiments, apparatus 100 may automatically begin operation by sensing a connection to a coolant supply. In this preferred embodiment, apparatus 100 includes button 200 for turning on apparatus 100.

Button 200 is disposed on a front side of apparatus 100 and may be used to turn on apparatus 100 after connections to a coolant system and a coolant supply have been established. After button 200 is pushed, apparatus 100 begins operating and operating light 202 may be illuminated to signal that apparatus 100 is on. In other embodiments, operating light 202 may not be included.

Preferably, an apparatus for servicing a coolant system includes provisions to facilitate ease of operation. In some embodiments, an electric button or switch may allow a user to charge a coolant system or measure a parameter of a coolant system. In other embodiments, a user may operate an apparatus using mechanical provisions. As discussed in the coolant system case, in a preferred embodiment one or more mechanical levers may be used to operate an apparatus for servicing a coolant system.

In the current embodiment, apparatus 100 may be operated by depressing and releasing levers 206. In this case, levers 206 are disposed on the sides of apparatus 100. This design may allow one handed operation of apparatus 100. In other embodiments, levers 206 may be disposed in another location on apparatus 100. As discussed previously in this detailed description and in the coolant system case, levers 206 preferably allow a user to manipulate switching device 110 to either allow communication between apparatus 100 and a coolant system while measuring the current pressure or to allow communication between a coolant supply and a coolant system while charging. Using this configuration, a user may switch between charging and measuring a parameter of a coolant system by depressing or releasing levers 206.

Preferably, an apparatus includes provisions to alert a user to a coolant charge status. As previously discussed, any type of indicating device may be utilized to alert a user to the coolant charge status of a coolant system. In some embodiments, a visual display of lights may be employed. In some cases, a visual display may be a digital display such as an LED, OLED or AMLCD display. In other embodiments, a set of sounds may be used to alert a user to the coolant charge status of a coolant system.

In a preferred embodiment, apparatus 100 includes display 208. In this embodiment, display 208 is an LED display and includes first light 221, second light 222, third light 223 and fourth light 224. In some cases, each light may be associated with a distinct color. In the current embodiment, first light 221, second light 222, third light 223 and fourth light 224 are associated with red, yellow, green and blue colors respectively. Although the current embodiment includes four lights, in other embodiments, more or less than four lights may be included. Additionally, in other embodiments, other colors for LED lights may be used.

Display 208 may alert a user of the coolant charge status of a coolant system. Additionally, display 208 may inform a user if apparatus 100 is ready to measure a parameter of a coolant system. Generally, display 208 may be configured to communicate any information related to the operation of apparatus 100. Using this arrangement, display 208 may communicate visually with a user of apparatus 100.

In this embodiment, sound and speech recordings may also be used to alert a user to the coolant charge status of a coolant system. Additionally, sound may be used to inform a user if apparatus 100 is ready to measure a parameter of a coolant system. Generally, sound and speech recordings may be used by apparatus 100 in any way to communicate with a user. For example, speech recordings may be used to read out a current pressure of a coolant system. Preferably, speaker 210 may be connected to audio device 116 and programmed to play sounds and speech recordings. With this preferred arrangement, apparatus 100 may play sound and speech recordings generated by audio device 116 through speaker 210 in order to alert or inform a user of information relevant to the operation of apparatus 100.

FIG. 3 illustrates a cut away view of the back side of the current embodiment of apparatus 100. For purposes of clarity, only some components of apparatus 100 may be illustrated in this Figure. For instance, only one of levers 206 is illustrated in order to increase the visibility of other components.

In some embodiments, apparatus 100 may include provisions for storing energy for operation of apparatus 100. In some cases, apparatus 100 may include provisions for using carbon batteries such as AA, C or D dry-cell batteries. In other cases, apparatus 100 may include provisions for using alkaline batteries. Generally, apparatus 100 may use any type of battery configured to provide energy to apparatus 100 for operation. In other embodiments, apparatus 100 may include some type of cord to connect to an external power source.

In this preferred embodiment, apparatus 100 includes cavities for insertion of four “AA” batteries. Batteries 320 may be inserted into apparatus 100 after a door on the back side of apparatus 100 is opened. In other embodiments, batteries 320 may be inserted in another manner. Using this arrangement, apparatus 100 may be operated free of the necessity of finding an outlet and without the constraint of a power cord connecting apparatus 100 to an external power source.

In this current embodiment, fluid channel 106 comprises first portion 307, second portion 308, and third portion 309. First portion 307 connects to a coolant system through hose 105 at first fluid port 101. Second portion 308 connects to a coolant supply at second fluid port 103 disposed at receiving end 204.

Third portion 309 of fluid channel 106 runs perpendicular to first portion 307 and second portion 308 and may provide fluid communication between first portion 307 and second portion 308. Additionally, third portion 309 may be associated with third fluid port 107. In a preferred embodiment, third portion 309 may be further associated with switching device 110 (shown in phantom) that may be disposed internally to third portion 309.

In some embodiments, switching device 110 may be located within third portion 309 of fluid channel 106. In other embodiments, switching device 110 may be located in another portion of fluid channel 106. Generally, switching device 110 is associated with levers 206 of which only one is shown here. Details of the connection between levers 206 and switching device 110 is discussed in the coolant system case. The connection between levers 206 and switching device 110 allows a user to manipulate switching device 110 between a first and second position by depressing and releasing levers 206.

As previously described, third fluid port 107 may allow fluid communication between a coolant system and first measuring device 108 when the switching device is in a second position. This preferred configuration allows fluid communication between a coolant supply, a coolant system and first measuring device 108.

Preferably, apparatus 100 includes provisions to control the direction that coolant flows through fluid channel 106. In some embodiments, a check valve may be placed within fluid channel 106 to permit one-way fluid communication between a coolant supply and apparatus 100. In other embodiments, other provisions may be employed to prevent fluid communication in unwanted directions. In a preferred embodiment, second portion 308 of fluid channel 106 may be configured with check valve 350 to permit one-way fluid communication between a coolant supply and apparatus 100. This preferred configuration may also prevent coolant from a coolant system from flowing into a coolant supply.

First measuring device 108 may be disposed near third portion 309 of fluid channel 106. In this embodiment, first measuring device 108 is a Bourdon tube pressure gauge fitted with a quadrature encoder. First measuring device 108 may measure the current pressure by counting window passings on a toothed wheel on first measuring device 108 using a quadrature encoder. In other embodiments, first measuring device 108 may measure the current pressure of a coolant system in another manner.

As previously discussed, second measuring device 118 may be configured to determine the current ambient temperature. In some embodiments, second measuring device 118 may be configured to determine the current ambient temperature at a precise time. In other embodiments, second measuring device 118 may constantly measure the current ambient temperature. In this embodiment, second measuring device 118 measures the current ambient temperature when levers 108 are depressed.

As previously discussed, control unit 112 may be connected to switching device 110, first measuring device 108 and second measuring device 118. Through the connection to switching device 110, control unit 112 receives information on the current position of switching device 110. Through the connection to measuring devices 108 and 118, control unit 112 receives information about the current pressure and the current ambient temperature.

In this preferred embodiment, apparatus 100 further includes storage device 120, display 208 and audio device 116 which preferably includes speaker 210. Each of these components 120, 208, and 116 may be connected to control unit 112, as previously discussed. As seen in FIG. 3, display 208 is disposed behind batteries 320 and audio device 116 may be placed near a front side of apparatus 100 in order to maximize the effectiveness of speaker 210. For purposes of clarity, storage device 120 is not shown in FIG. 3.

Generally, each of components 106, 108, 116, 118, 112, 120, 208 and 320 may be disposed anywhere within apparatus 100. Although the current embodiment shown in FIG. 3 illustrates a preferred position for components 106, 108, 116, 118, 208 and 320, in other embodiments, components 106, 108, 116, 118, 208 and 320 may be located elsewhere according to the internal volume of apparatus 100 as well as other considerations.

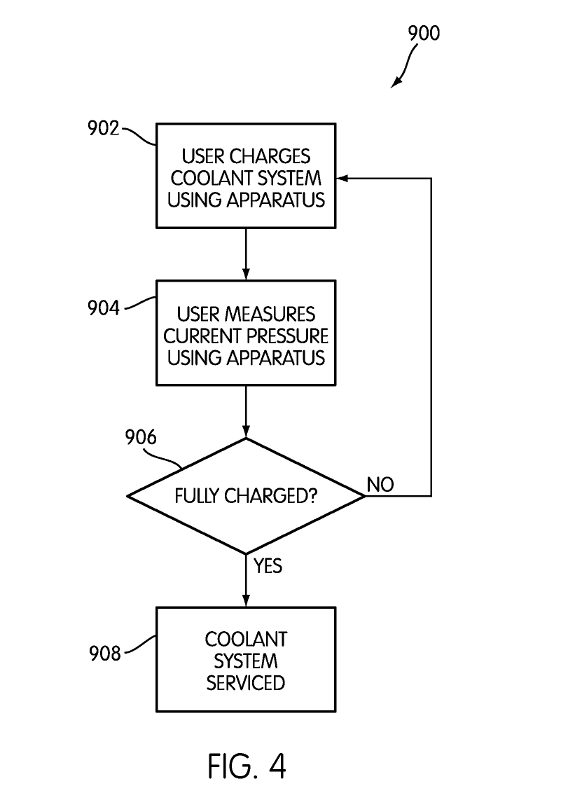

FIG. 4 is a preferred embodiment of process 900 for operating apparatus 100 to service a coolant system. In this embodiment, the following steps are preferably performed by a user. As mentioned previously, the user may be a “do-it-yourself” consumer. In other embodiments, the user may be a service technician.

During first step 902, the user charges a coolant system with coolant with a charging apparatus. After some period of charging that increases the coolant level of the coolant system, the user proceeds to second step 904. During second step 904, the user measures a current pressure of the coolant system, and in some cases, the ambient pressure, using the apparatus. After measuring the current pressure of the coolant system, the user is alerted to the coolant charge status and proceeds to third step 906.

During third step 906, the user, provided with the coolant charge status from an indicating device, determines if the coolant system is fully charged. If the coolant system is fully charged, the user preferably proceeds to fourth step 908. During fourth step 908, the user has completed the servicing of the coolant system and may turn off apparatus 100. Alternatively, if the user determines that the coolant system is not fully charged at step 906, the user preferably returns to first step 902 and charges the coolant system with more coolant using apparatus 100. In this case, the user may proceed again through the steps as described above.

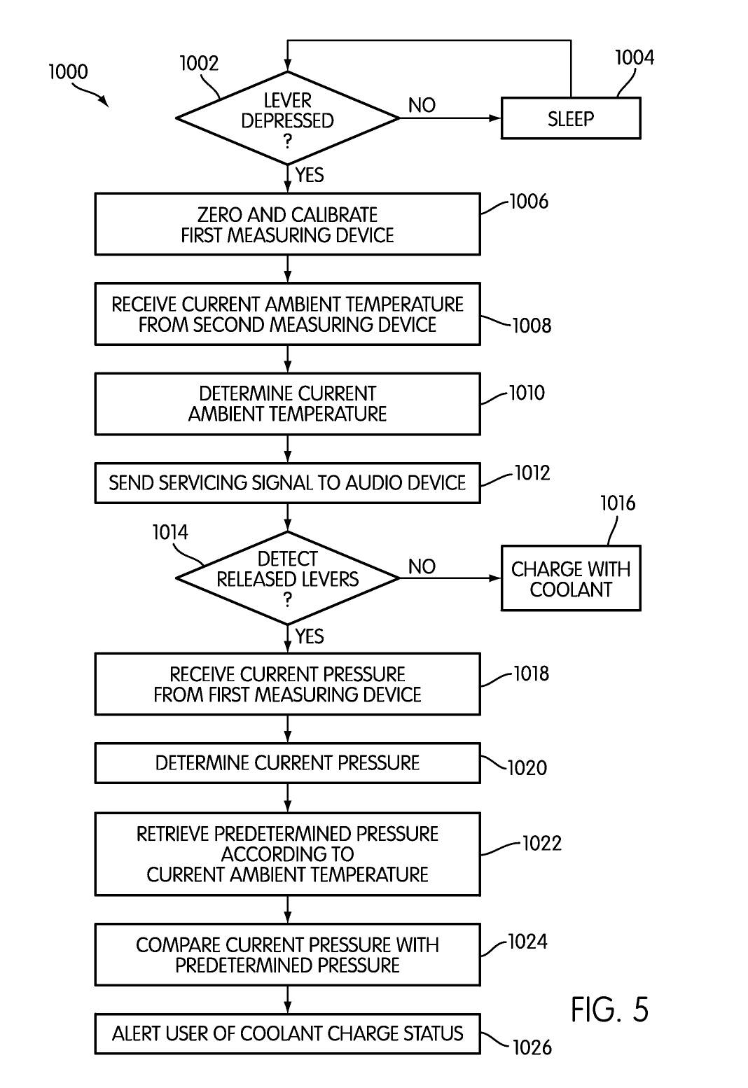

While the user operates apparatus 100, apparatus 100 preferably proceeds through additional steps to perform the operations of charging and measuring the current pressure of a coolant system. FIG. 5 is a preferred embodiment of process 1000 for operating apparatus 100 to service a coolant system. In this embodiment, the following steps are preferably performed by control unit 112; however in some embodiments components of apparatus 100 other than control unit 112 may be configured to perform these steps.

In this embodiment, apparatus 100 has preferably been turned on with button 200. In other embodiments, apparatus 100 may turn on automatically when a connection to a coolant system is detected or when levers 206 are depressed. During step 1002, control unit 112 determines if levers 206 are depressed. If levers 206 are not depressed, control unit 112 preferably proceeds to step 1004 and sleeps. After some time of sleeping, control unit 112 preferably returns to step 1002 to check if levers 206 are depressed. If levers 206 are depressed, control unit 112 preferably proceeds to step 1006. As mentioned previously in this detailed description, when levers 206 are depressed, switching device 110 is placed in a first position establishing fluid communication between a coolant system and a coolant supply.

During step 1006, control unit 112 signals first measuring device 108 to calibrate so that a current pressure measurement would yield a value of zero. In other words, all future pressure measurements will be relative to the current pressure value, rather than recording absolute pressure values. After step 1006, control unit 112 proceeds to step 1008. During step 1008, control unit 112 receives current ambient temperature information from second measuring device 118. Following step 1008, control unit 112 proceeds to step 1010 and determines the current ambient temperature. After step 1010, control unit 112 proceeds to step 1012.

At step 1012, control unit 112 signals audio device 116 to alert user 400 that first measuring device 108 is ready to measure a current pressure. Following step 1012, control unit 112 continues to step 1014. During step 1014, control unit 112 detects if levers 206 have been released. If levers 206 have not been released, control unit 112 proceeds to step 1016 and charges coolant from a coolant supply to a coolant system.

During step 1014, if control unit 112 determines that levers 206 have been released, control unit 112 proceeds to step 1018. During step 1018, control unit 112 receives current pressure information from first measuring device 108. Control unit 112 then proceeds to step 1020 and determines the current pressure of the coolant system. Following step 1020, control unit 112 preferably proceeds to step 1022. During step 1022, control unit 112 retrieves a predetermined pressure according to the current ambient temperature from a lookup table.

Following step 1022, control unit 112 preferably proceeds to step 1024. During step 1024, control unit 112 compares the current pressure with the predetermined pressure retrieved from the lookup table to determine a coolant charge status for the coolant system. Control unit 112 then preferably proceeds to step 1026. During step 1026, control unit 112 alerts user 400 of the coolant charge status. As mentioned previously in this detailed description, indicating devices may be included in apparatus 100. In this embodiment, control unit 112 alerts user 400 of the coolant charge status using display 208. Additionally, in some embodiments, control unit 112 may alert user 400 of the current pressure using audio device 116. Following step 1026, control unit 112 may return to step 1002 and continue proceeding through the steps described in process 1000.

In some embodiments, the steps of operating an apparatus may proceed in a different manner. For example, an apparatus may charge a coolant system with coolant when levers are released and measure a parameter of a coolant system when levers are depressed. Indicating devices may also be employed in a different manner. For example, an apparatus may not signal an indicating device such as an audio device when a measuring device is ready to measure. In other embodiments, there may be additional steps included in the operation of an apparatus. In some cases, other parameters of a coolant system may be measured.

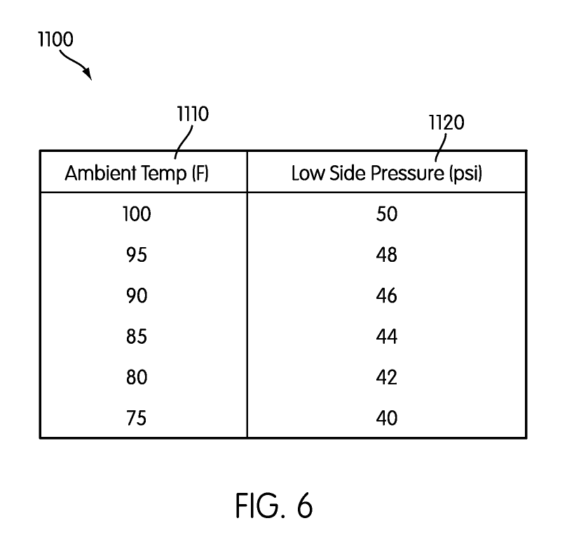

FIG. 6 is an exemplary embodiment of a portion of lookup table 1100. Lookup table 1100 contains ambient temperatures 1110 associated with predetermined pressures shown as low side pressures 1120. Lookup table 1100 is designed with predetermined pressures calculated for a low pressure service port. A lookup table for a high pressure service port may also be stored in an apparatus. In other embodiments, lookup tables for both a low pressure service port and a high pressure service port may be stored in a storage device or in another component of the apparatus. In some cases, lookup table 1100 may include not only low side pressure 1120 but also predetermined pressures for a high pressure service port for ambient temperatures 1110.

In this embodiment, ambient temperatures 1110 are expressed in Fahrenheit units and low side pressures 1120 are expressed in psi units. In other embodiments, ambient temperatures 1110 and low side pressures 1120 may be stored in other units. The values for both ambient temperatures 1110 and low side pressures 1120 in lookup table 1110 are for illustrative purposes only.

For clarity, only a portion of lookup table 1100 is shown in this Figure. The range of ambient temperatures 1110 extends from 75 degrees Fahrenheit to 100 degrees Fahrenheit; however, in other embodiments lookup table 1100 may include any range of ambient temperatures 1110. In this exemplary embodiment, lookup table 1100 contains ambient temperatures 1110 at 5 degree intervals including 75 degrees, 80 degrees, 85 degrees, 90 degrees, 95 degrees and 100 degrees. In other embodiments, lookup table 1100 may contain ambient temperatures 1110 at 1 degree intervals. Generally, ambient temperatures 1110 may be entered in any manner so that a low side pressure 1120 may be retrieved.

Preferably, lookup table 1100 may be used to retrieve a predetermined pressure for a low side service port for an associated ambient temperature. Referring to this exemplary embodiment, if the current ambient temperature is measured at 85 degrees Fahrenheit then lookup table 1100 will return a value of 44 psi for a low side pressure. Accordingly, if the current ambient temperature is measured at 95 degrees Fahrenheit then lookup table 1100 will return a value of 48 psi for a low side pressure. This preferred arrangement allows the apparatus to retrieve a predetermined pressure for an associated ambient temperature.

In this embodiment, if a current ambient temperature is determined to be a value that falls between the 5 degree intervals of lookup table 1100, then the current ambient temperature may be rounded up. For example, if the current ambient temperature is 83 degrees then the current ambient temperature will be rounded up to 85 degrees and the associated low side pressure will be 44 psi. In other embodiments, the current ambient temperature may be rounded down.

In some embodiments, a predetermined pressure range instead of a predetermined pressure may be associated with an ambient temperature. A predetermined range may include a predetermined maximum pressure and a predetermined minimum pressure. This arrangement may allow for a greater, and possibly more specific, range of values of current pressure to be included in a predetermined pressure range.

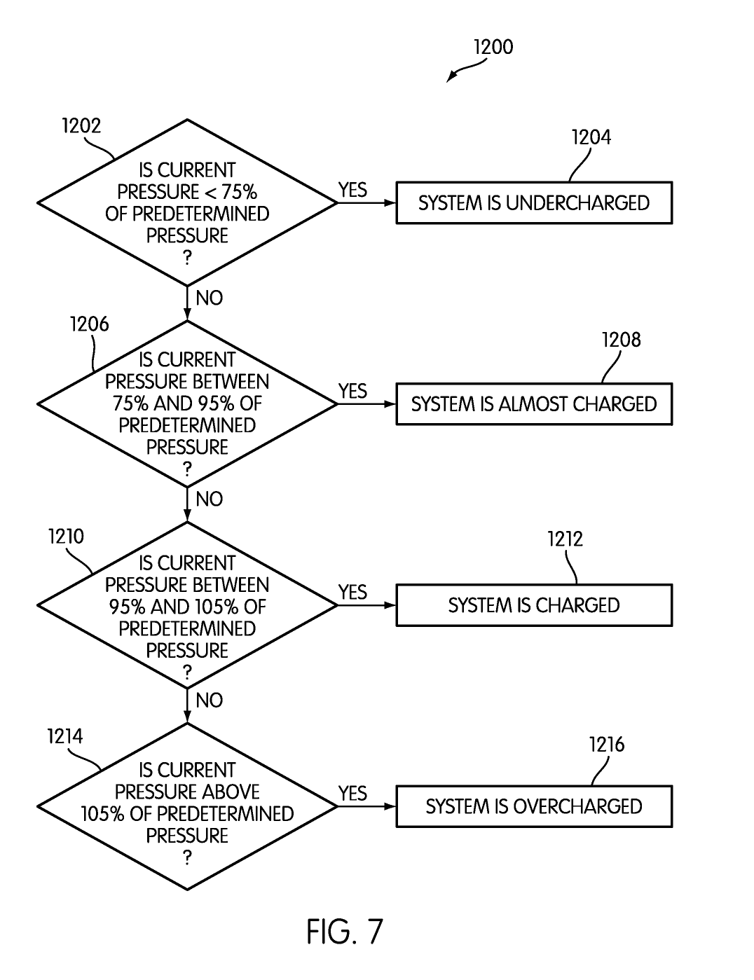

FIG. 7 is a preferred embodiment of process 1200. Process 1200 is a detailed process of step 1024 (see FIG. 5) of comparing the current pressure with a predetermined pressure and determining a coolant charge status of a coolant system. In a preferred embodiment, process 1200 is executed by control unit 112 after control unit 112 receives a current pressure from first measuring device 108 and a predetermined pressure from a lookup table. In other embodiments, detailed process 1200 may be executed by other components or combinations of components of apparatus 100.

In step 1202, control unit 112 determines if the current pressure is less than 75 percent of the predetermined pressure. If the current pressure is less than 75 percent of the predetermined pressure, then control unit 112 proceeds to step 1204. During step 1204, control unit 112 determines that the coolant charge status is undercharged.

During step 1202, if control unit 112 determines the current pressure is not less than 75 percent of the predetermined pressure, control unit 112 proceeds to step 1206. During step 1206, control unit 112 determines if the current pressure is between 75 percent and 95 percent of the predetermined pressure. If the current pressure is within 75 percent and 95 percent of the predetermined pressure, then control unit 112 proceeds to step 1208. During step 1208, control unit 112 determines that the coolant charge status is almost charged.

If control unit 112 determines the current pressure is not within 75 percent and 95 percent of the predetermined pressure at step 1206, control unit 112 proceeds to step 1210. During step 1210, control unit 112 determines if the current pressure is between 95 percent and 105 percent of the predetermined pressure. If the current pressure is within 95 percent and 105 percent of the predetermined pressure, control unit 112 proceeds to step 1212. During step 1212, control unit 112 determines the coolant charge status is charged. As

During step 1210, if control unit 112 determines the current pressure is not within 95 percent and 105 percent of the predetermined pressure, control unit 112 proceeds to step 1214. During step 1214, control unit 112 determines if the current pressure is over 105 percent of the predetermined pressure. If the current pressure is over 105 percent of the predetermined pressure, then control unit 112 proceeds to step 1216. During step 1216, control unit 112 determines that the coolant charge status is overcharged.

The current embodiment of a method for comparing current pressures with predetermined pressures is only intended to be exemplary. In some embodiments, other percentage ranges may be used to define a coolant charge status of undercharged, almost charged, charged, and overcharged. In other embodiments, other methods of comparing current pressures and predetermined pressures may be used.

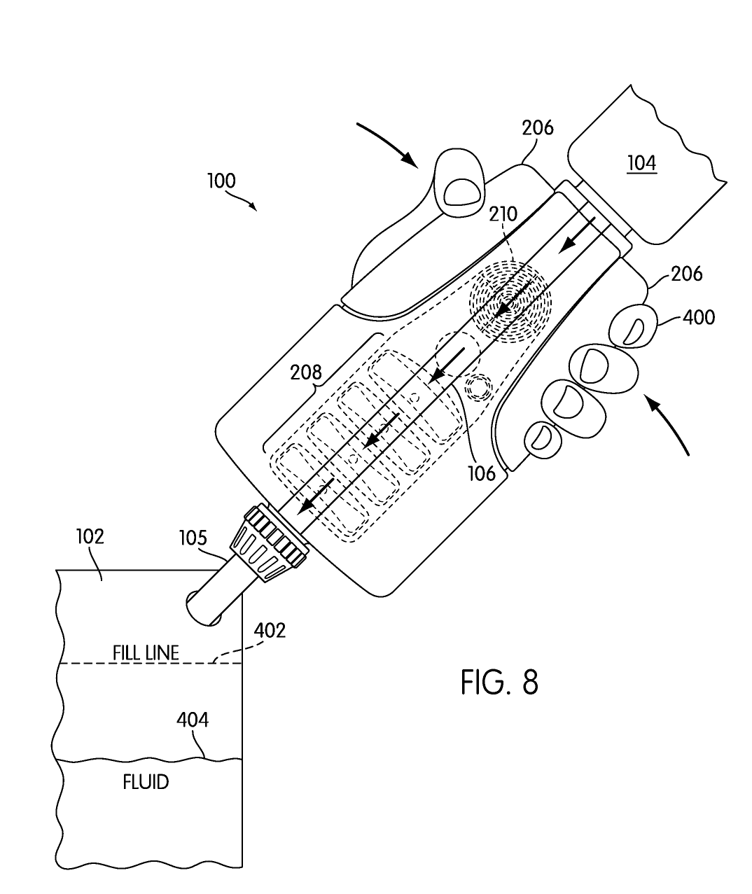

FIGS. 8-12 illustrate a preferred embodiment of the operation of apparatus 100 by a user 400. The following discussion is intended to be exemplary and in other embodiments apparatus 100 may be operated in a different manner. In this embodiment, prior to operating apparatus 100, user 400 preferably connects apparatus 100 to coolant system 102 using hose 105. Additionally, user 400 preferably connects coolant supply 104 to apparatus 100. In this embodiment, user 400 is a “do-it-yourself” consumer and may not be professionally trained in servicing coolant systems. In other embodiments, however, user 400 may be a service technician.

Generally, the pressure of a coolant within a coolant system will be directly related to the amount of coolant in the coolant system, as the volume of the coolant system generally remains constant. In other words, adding coolant will increase the pressure within the coolant system, while removing coolant will decrease the pressure within the coolant system. Therefore, to illustrate changes in the coolant pressure, coolant system 102 has been illustrated schematically in FIGS. 8-12 to include a reservoir of coolant. This allows changes in the amount of coolant, which are directly related to changes in the coolant pressure, to be visualized. It should be understood, however, that a coolant system may not include a reservoir of coolant. Instead, the coolant may be distributed through a series of tubes and other components. Therefore, the current embodiment is only intended to illustrate changes in the amount of coolant within coolant system 102 in a schematic manner.

Referring to FIG. 8, the initial coolant charge status of coolant system 102 is undercharged. In this case, coolant level 404 is well below fill line 402. Preferably, user 400 initiates charging of coolant system 102 with coolant supply 104 by depressing levers 206. As levers 206 are depressed, coolant flows from coolant supply 104 to coolant system 102 and coolant level 404 increases. In this Figure, a portion of the front side of apparatus 100, including display 208 and speaker 210, is shown in phantom, so that fluid channel 106 may be clearly seen. With this arrangement, fluid channel 106 conveys coolant from coolant supply 104 to coolant system 102 through hose 105.

In some embodiments, as levers 206 are depressed, an ambient temperature measurement may also be made using the previously discussed method. In particular, the control unit may receive information from the second measuring device that is configured to monitor ambient temperatures.

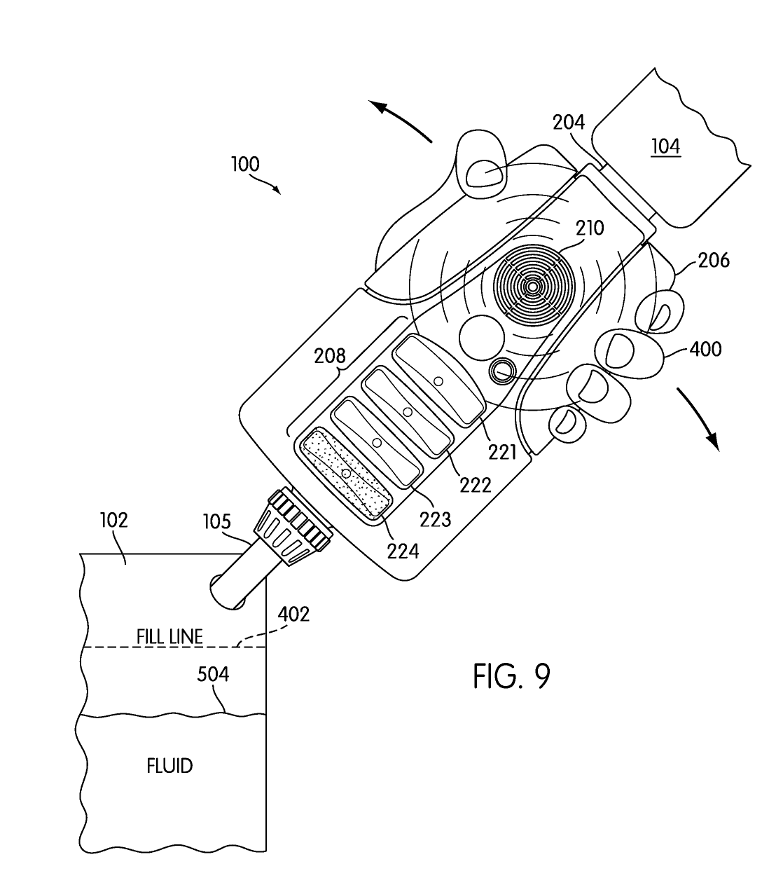

Referring to FIG. 9, user 400 releases levers 206 to determine the coolant charge status of coolant system 102 using the previously discussed method. In particular, the control unit may determine a predetermined pressure according to the ambient temperature. Also, the control unit may receive information about a current pressure from the first measuring device. Following this, the control unit may compare the predetermined pressure with the current pressure to determine the coolant charge status. Preferably, the coolant charge status may be sent to a display.

In this case, coolant level 504 of coolant system 102 has increased, but remains well below fill line 402, so the system is well undercharged. At this point, apparatus 100 displays the coolant charge status on display 208. In this preferred embodiment, fourth light 224 is illuminated as a blue light to indicate coolant system 102 is well undercharged. Furthermore, speaker 210 notifies user 400 of the current pressure of coolant system 102 through a speech recording.

In other embodiments, apparatus 100 may use other indicating devices to inform a user of either the coolant charge status or the current pressure or both. In some embodiments, display 208 may be used to communicate the current pressure of coolant system 102. Speaker 210 may notify user 400 of the coolant charge status through a series of beeps or a speech recording.

At this point, user 400 may decide to continue charging coolant system 102 by depressing levers 206. Preferably, coolant system 102 is charged again in the manner shown in FIG. 8. After some period of charging that increases the coolant level of coolant system 102, user 400 stops charging coolant system 102 so that the current pressure of coolant system 102 may be measured.

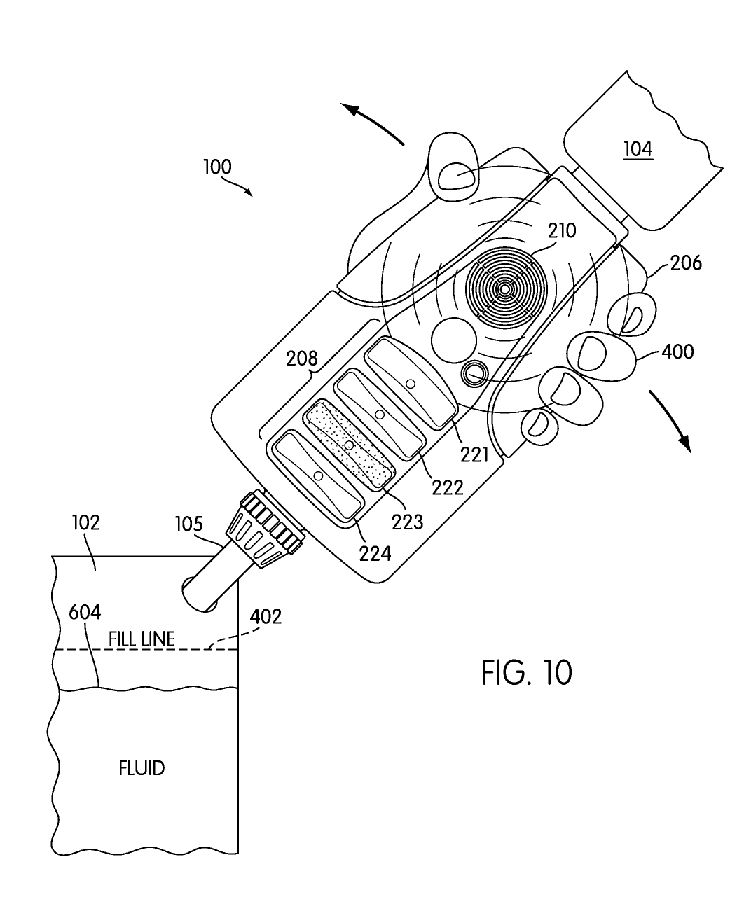

Referring to FIG. 10, user 400 releases levers 206 to determine the coolant charge status of coolant system 102. In this case, coolant level 604 in coolant system 102 has increased, but still remains slightly below fill line 402. After determining the current coolant charge status, apparatus 100 displays the coolant charge status on display 208. In this preferred embodiment, third light 223 is illuminated as a green light to indicate coolant system 102 is almost charged. Additionally, speaker 210 notifies user 400 of the current pressure of coolant system 102 through a speech recording.

In some cases, user 400 may decide to continue charging coolant system 102 by depressing levers 206. Coolant system 102 is charged again in the manner shown in FIG. 8. After some period of charging that increases the coolant level of coolant system 102, user 400 may decide to stop charging the coolant system so that the current pressure of coolant system 102 may be measured.

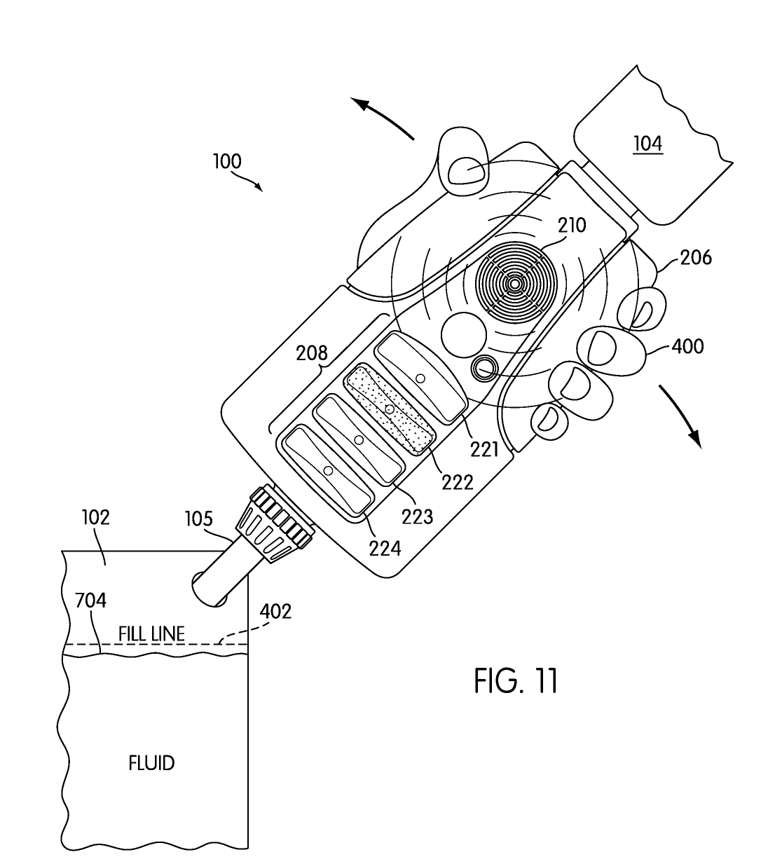

Referring to FIG. 11, user 400 releases levers 206 to measure the current pressure of coolant system 102. At this point, coolant level 704 has increased and is approximately at the same level as fill line 402. After determining the current coolant charge status, apparatus 100 displays the coolant charge status on display 208. In this preferred embodiment, second light 222 is illuminated as a yellow light to indicate coolant system 102 is correctly charged. Additionally, speaker 210 notifies user 400 of the current pressure of coolant system 102 through a speech recording.

After coolant system 102 is charged correctly, user 400 may be finished servicing coolant system 102. However, in some cases, user 400 may accidentally charge coolant system 102 beyond a correct charge level. In such cases, user 400 may continue charging coolant system 102, which is already correctly charged. Coolant system 102 is charged again in the manner shown in FIG. 8. After some period of charging that increases the coolant level of coolant system 102, user 400 stops charging coolant system 102.

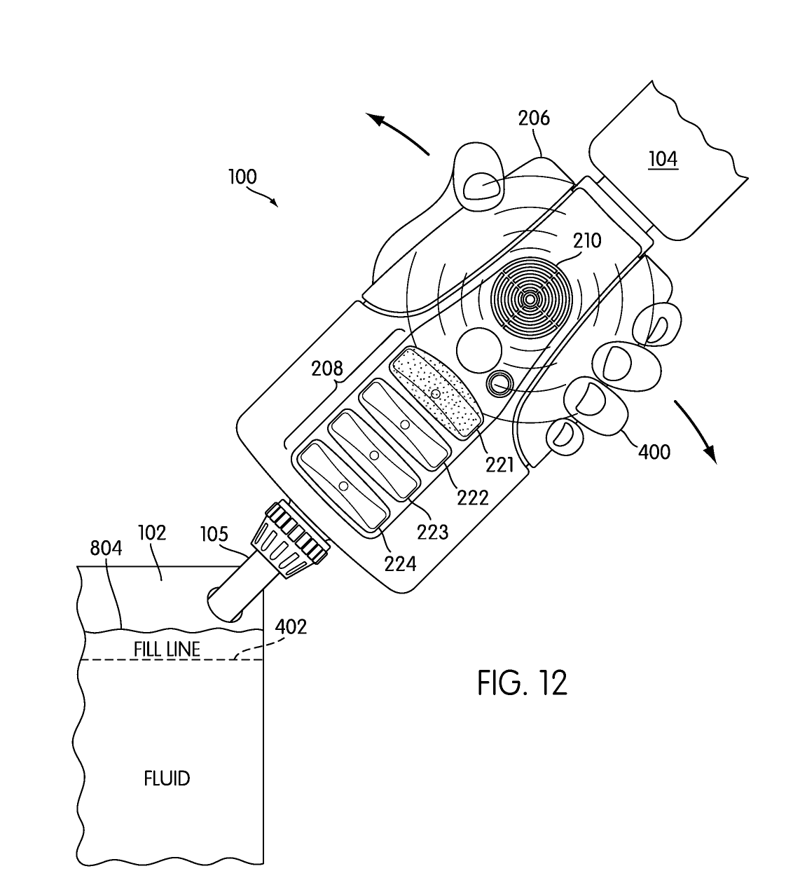

FIG. 12 illustrates user 400 releasing levers 206 to measure the current pressure of coolant system 102. In this case, coolant level 804 has increased and is substantially above fill line 402. After determining the current coolant charge status, apparatus 100 displays the coolant charge status on display 208. In this preferred embodiment, first light 221 is illuminated as a red light to indicate coolant system 102 is overcharged. Furthermore, speaker 210 notifies user 400 of the current pressure of coolant system 102 through a speech recording. In some embodiments, user 400 may need to empty coolant from coolant system 102. This may be accomplished by removing hose 105 and venting coolant system 102 in some manner. Following this, user 400 may repeat the prior steps of filling coolant system 102 and stopping to check the current pressure until a correct charge is obtained.

In this embodiment, display 208 indicates an undercharged configuration by illuminating fourth light 224, an almost charged configuration by illuminating third light 223, a correctly charged configuration by illuminating second light 222, and an overcharged configuration by illuminating light 221. In this preferred embodiment, first light 221 is a red light, second light 222 is a yellow light, third light 223 is a green light and fourth light 224 is a blue light. In other embodiments, different numbers and different colors of lights may comprise display 208. In other cases, lights 221-224 may flash instead of staying on. Furthermore, in an alternative embodiment, a digital LED display may be used to display the actual pressure of the coolant system. Any configuration of LED displays or other display devices may be used with display 208 to indicate the coolant charge status or alternatively, the current pressure of coolant system 102.

While various embodiments of the invention have been described, the description is intended to be exemplary, rather than limiting and it will be apparent to those of ordinary skill in the art that many more embodiments and implementations are possible that are within the scope of the invention. Accordingly, the invention is not to be restricted except in light of the attached claims and their equivalents. Also, various modifications and changes may be made within the scope of the attached claims.

We claim:

1. An apparatus for servicing a coolant system adapted to receive coolant from a coolant supply, comprising:
a first measuring device configured to measure a current pressure associated with the coolant system;
a second measuring device configured to measure a current ambient temperature;
a storage device configured to store a set of predetermined pressures associated with current ambient temperatures; and
a control unit in communication with the first measuring device, the second measuring device and the storage device configured to determine a coolant charge status; and
an indicating device in communication with the control unit configured to alert a user of the coolant charge status.

2. The apparatus according to claim 1, wherein the first measuring device is a Bourdon tube pressure gauge fitted with a quadrature encoder.

3. The apparatus according to claim 1, wherein the second measuring device is a thermistor.

4. The apparatus according to claim 1, wherein the indicating device is a display device.

5. The apparatus according to claim 4, wherein the display device includes at least one LED light.

6. The apparatus according to claim 1, wherein the indicating device includes an audio device.

7. The apparatus according to claim 6, wherein the audio device includes a voice processor and a speaker.

8. A method of servicing a coolant system using an apparatus attached to a coolant supply, comprising the steps of:
receiving information related to a current pressure of the coolant system and receiving information related to a current ambient temperature;
retrieving a predetermined pressure associated with the current ambient temperature from a storage device;
comparing the current pressure with the predetermined pressure and determining a coolant charge status; and
sending information related to the coolant charge status to an indicating device for alerting a user.

9. The method according to claim 8, wherein a plurality of predetermined pressures associated with a plurality of ambient temperatures is stored in a lookup table associated with the storage device.

10. The method according to claim 8, wherein the apparatus includes a switching device.

11. The method according to claim 10, wherein the switching device is configured to provide fluid communication between the coolant system and the coolant supply in a first position.

12. The method according to claim 10, wherein the switching device is configured to provide fluid communication between the coolant system and a first measuring device in a second position.

13. The method according to claim 12, wherein the switching device can be configured in either the first position or the second position using one or more levers.

14. The method according to claim 8, wherein the indicating device includes a plurality of LED lights.

15. The method according to claim 14, wherein the step of sending information related to the coolant charge status includes a step of activating one of the plurality of LED lights.

16. The method according to claim 8, wherein the indicating device includes an audio device.

17. The method according to claim 16, wherein the step of sending information related to the coolant charge status includes a step of activating a speaker associated with the audio device.

18. An apparatus for servicing a coolant system adapted to receive coolant from a coolant supply, comprising:
a first measuring device configured to measure a current pressure associated with the coolant system;
a second measuring device configured to measure a current ambient temperature;
a switching device providing fluid communication between the coolant system and the coolant supply in a first position and providing fluid communication between the coolant system and the first measuring device in a second position;
a control unit in communication with the first measuring device, the second measuring device and the switching device; and
wherein the control unit receives information from the second measuring device when the switching device is in the first position and wherein the control unit receives information from the first measuring device when the switching device is in the second position.

19. The apparatus according to claim 18, wherein the control unit is in communication with a storage device including a plurality of predetermined pressures associated with a plurality of ambient temperatures.

20. The apparatus according to claim 18, wherein the control unit is in communication with an indicating device that is configured to alert a user of a coolant charge status.
